(19) United States
(12) Patent Application Publication
(10) Pub. No.: US 2025/0104170 A1
(43) Pub. Date: Mar. 27, 2025

(54) UNIVERSAL LEGAL AID

(71) Applicant: ZACK Y LAM, BETHESDA, MD (US)

(72) Inventor: ZACK Y LAM, BETHESDA, MD (US)

(21) Appl. No.: 18/795,988

(22) Filed: Aug. 6, 2024

Related U.S. Application Data
(60) Provisional application No. 63/540,086, filed on Sep. 24, 2023.

(51) Int. Cl. G06Q 50/18

(52) U.S. Cl. CPC G06Q 50/18

(57) ABSTRACT

A Universal Legal Aid (ULA) has a series of AI services that draw from a data aggregation layer (DAL) to answer user inquiries regarding the law. Requests are understood through AI natural language processing, whereupon a Retrieval Service (RS) extracts relevant laws and the attached analysis from the legal data aggregation layer and returns it to the user. These processes are built upon the Compilation Service (CS), which combines laws of a variety of geographical areas into the DAL, and the Analysis Service (AS), which uses the DAL law texts to generate information, such as analysis, summary, advice, and annotation. The DAL contains laws of all nations from the national/federal to the local level, as well as international law.

### CROSS-REFERENCE TO RELATED APPLICATIONS

This application claims the priority date of U.S. Provisional Patent Application, No. 63/540,086 filed on Sep. 24, 2023, the entire content of which is incorporated herein by reference.

### BACKGROUND OF THE INVENTION

The present invention is in the technical field of information technology, more particularly, in the field of universal legal aid (ULA) using artificial intelligence (AI) cloud technology. The ULA has a series of AI services that draw from a data aggregation layer (DAL) to answer user inquiries regarding the law. The DAL accumulates laws from local to federal levels, as well as international law of other nations through a Compilation Service (CS). User inquiries are processed by an AI natural language processor (NLP) unit and a retrieval service (RS) that extracts relevant laws and associated analysis from the DAL. The results are displayed in any digital smart device, such as mobile phone, laptop, car screen or desk computer.

The described ULA can be applied in various situations where users require legal information, guidance, or analysis. Here are some examples of situations where this ULA are utilized:
1. A person facing a legal issue, such as a tenant dealing with a landlord dispute, an employee facing workplace discrimination or a citizen being detained by the authority in any situations, can use the ULA to ask questions about their rights, responsibilities, and possible legal actions. The system provides relevant laws, regulations, and case precedents to help them understand their situation better.
2. Citizens who may have to give up their home because of eminent domain or expropriation can consult the ULA, which could help to acquire just compensation, argue a lack of justified public use or understand their rights in that instance.
3. Individuals looking to immigrate to a different country can utilize the ULA to gather information about the immigration laws, visa processes, and eligibility criteria of their destination country.
4. Legal professionals can employ the ULA to quickly access a wide range of legal sources, enabling them to research and build stronger cases for their clients. This involves finding relevant statutes, case laws, and legal commentaries.
5. Law students and legal researchers use the ULA to enhance their learning process. They can ask complex legal questions and receive comprehensive answers that include citations and references, helping them deepen their understanding of legal concepts.

6. Individuals and businesses involved in international transactions use the ULA to navigate the complexities of cross-border contracts, trade agreements, and intellectual property rights.

In all these situations, the ULA leverages its AI-driven capabilities to process user inquiries, extract pertinent information from the DAL, and provide accurate and relevant legal guidance. The goal is to make legal information more accessible and comprehensible to users across a wide range of legal contexts.

### SUMMARY OF THE INVENTION

One embodiment of the present invention is to provide a ULA platform with system and method for retrieving legal advice and analysis through a variety of AI services.

Another embodiment of the present invention is to demonstrate that the AI services draw information from local, state, federal, and international law through a CS.

Another embodiment of the present invention demonstrates the processes of associated laws of a variety of geographical areas stored in the DAL.

Another embodiment of the present invention is to demonstrate the ULA system caters to a variety of users, including the general public and legal scholars.

Another embodiment of the present invention demonstrates the legal scholars' requests are understood through an AI NLP, relevant laws are extracted by a RS, then analysis are performed through an AS, attached to and stored in the DAL.

Another embodiment of the present invention is to use a ULA to answer user inquiries through an AI NLP using a RS and an AS.

### BRIEF DESCRIPTION OF THE DRAWINGS

FIG. 1 is a schematic diagram of a ULA model of the present invention.

FIG. 2 is a schematic diagram of the Cloud Processing (CP) components in the ULA of the present invention.

FIG. 3 is a schematic diagram of the Compilation Service (CS) of the present invention.

FIG. 4 is a schematic diagram of the Retrieval Service (RS) of the present invention.

FIG. 5 is a schematic diagram of the Analysis Service (AS) of the present invention.

### DETAILED DESCRIPTION OF THE INVENTION

The present invention is a cutting edge digital legal aid, poised to improve the way individuals access legal counsel and analysis. By harnessing the power of artificial intelligence, this system offers users an unprecedented avenue to seek and obtain comprehensive legal advice and analysis, drawing from an extensive array of legal sources spanning local, state, federal and even international law.

This forward looking solution caters to two distinct categories of users: the general public and legal scholars. For the general public, the technology employs a unique jargon simplification mechanism, ensuring that intricate legal concepts are distilled into easily understandable language, enabling even those without a legal background to comprehend and navigate the complexities of the law. On the other hand, legal scholars are presented with an additional layer of functionality, empowering them not only to access existing legal analyses but also to contribute their own insights and interpretations to the platform.

The underlying framework of this innovation rests upon two key pillars: the law compilation service and the analysis service. The law compilation service orchestrates the combination of legal statutes and regulations from diverse geographic areas, culminating in the DAL. This centralized repository forms the foundation upon which subsequent processes rely, ensuring that a comprehensive and up-to-date collection of legal texts is readily available for analysis.

Complementing the law compilation service, the AS serves as the cognitive engine that drives the system's analytical capabilities. By harnessing the wealth of legal information stored within the DAL, this service leverages advanced AI algorithms to generate a spectrum of analyses, encompassing detailed legal insights, summaries, actionable advice, and insightful annotations. This ULA device caters to users with varying levels of legal acumen and diverse requirements, demonstrating the system's versatility and inclusivity.

In essence, the present invention seamlessly melding cutting edge technology with the intricacies of the legal realm. It dismantles barriers to legal comprehension, making the law accessible to all. Through the harmonious interplay of the CS and the AS, this ULA reshapes the landscape of legal consultancy and analysis, fostering a more informed and empowered users.

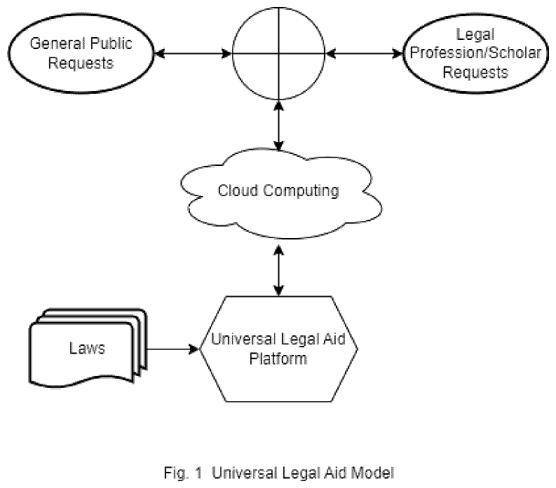

Referring now to FIG. 1, a general ULA model of the present invention is shown. Specifically, the ULA caters to two distinct user categories: the general public and legal scholars. Users submit their inquiries to a Universal Legal Access Platform (ULAP), which draws its law information from various domains, all through Cloud Processing (CP).

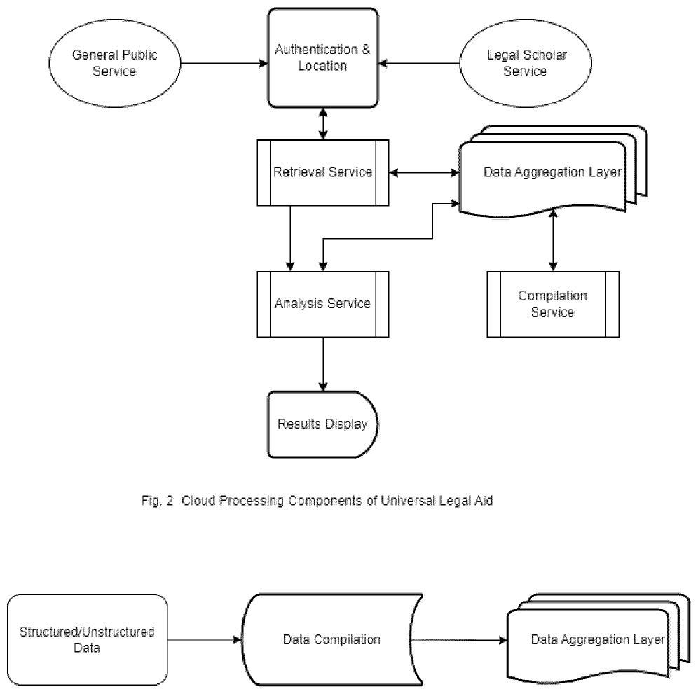

Referring now to FIG. 2, FIG. 2 illustrates the CP components utilized in the ULA of the present invention. In particular, the CP includes an Authority and Location Unit (ALU), a Retrieval Service (RS), a Data Aggregation Layer (DAL), a Compilation Service (CS), an Analysis Service (AS), and a Results Display.

Initially, the general public and legal scholar users have to obtain authorization and identify their location prior to accessing the ULA system for their legal-related inquiries. Any biometric authentication, such as fingerprints, facial recognition, including Interactive Voice Response (IVR) system using Caller ID as authentication can be used within the ULA of the present invention. IVR system is an automated telephone system that combines pre-recorded messages or text-to-speech technology to engage callers, providing information without a live agent. By integrating computer and telephony technologies, IVR software can improve call flow and reduce wait times, leading to higher overall customer satisfaction.

With the advent of Artificial Intelligence (AI), Big Data (BD), IoT, and Chat Generative Pre-trained Transformer (ChatGPT), the present invention could be easily integrated to provide faster verification or authentication process, and more meaningful data analysis and insights on any legal inquiries. IVR system is also evolving with the development of Artificial Intelligence (AI) and Natural Language Processing (NLP) technology expanding the range of ways that users can now interact with the ULA on the phone.

Once their identity and location have been verified, those inquiries will be sent to the RS for processing. The RS triggers the DAL to scour diverse legal sources across numerous domains. The outcome of this process is a consolidated repository of these legal provisions unified within the platform. The results will be displayed in a text report format on any appropriate smart device, encompassing laptops, smartphones, and equivalents. The interconnection between the user's device and the legal data aggregation permits seamless access to cloud-hosted services and essential legal insights.

Samples of services available for the general public:
a. Law Source and Text Retrieval
b. Analysis Retrieval and Generation
c. Inquiry-Tailored Advice
d. Jargon Simplification

Samples of services available for legal scholars:
a. Law Source and Text Retrieval
b. Analysis Retrieval and Generation
c. Inquiry-Tailored Advice
d. Document Review

The user inquiries are processed by two specific services: the Compilation Service (CS) for aggregation, then the law Analysis Service (AS) for annotation and comments. The CS collects and compiles all the aforementioned law-relevant data into a Data Aggregation Layer (DAL). These combined compilation and analysis processes are responsible for creating a platform of aggregated legal data, also known as the Universal Legal Access Platform (ULAP) shown in FIG. 1.

Referring now to FIG. 3, information is feeding into the CS. The cumulated results are then supplied to the RS. The information comprises both structured and unstructured data in the form of laws, court rulings, and news media. These components made up the law compilation service of the present invention.

Samples of data collected by the CS:
1. Laws
   a) International b) Federal
   c) State
   d) Local
2. Court Rulings
   a) International
   b) Federal
   c) State
   d) Local
3. News Media

The international laws and court rulings mentioned referred to those crafted by international organizations, i.e., United Nations (UN) International Court of Justice, and laws of individual countries and regions outside the borders of the United States of America.

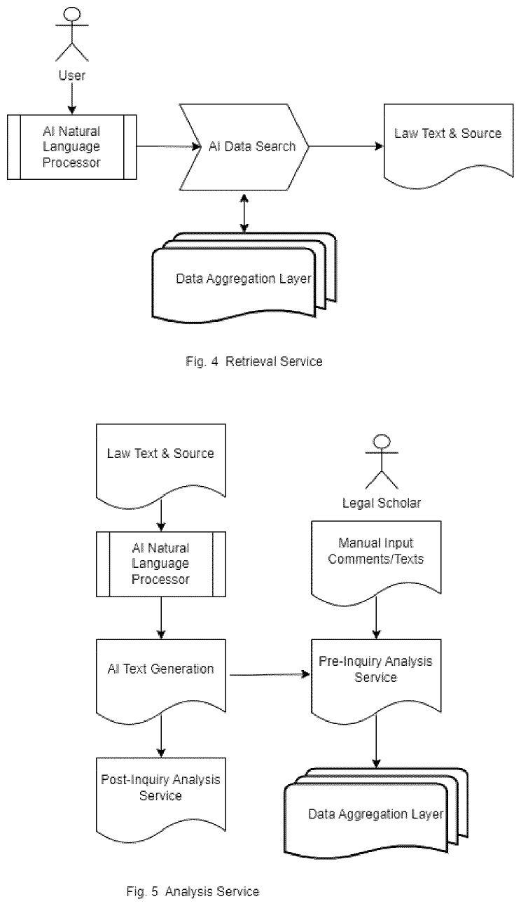

Referring to FIG. 4, a Retrieval Service (RS) that retrieves law-related inquiries (text and source) from the DAL is shown. In more detail, the RS understands and processes the user inquiries through an AI subservice, the AI Natural Language Processor (NLP), whereupon it can browse the DAL through a dataset search. After searching through the DAL, the RS retrieves the law(s) most relevant to the user inquiries and displays its text and source on user's smart device.

Referring now to FIG. 5, an Analysis Service (AS) is shown. This service is made up of two kinds of analysis. One is inherently tied to each individual law and created before any user inquiry, outputting analysis, annotation, and summary, known as pre-inquiry analysis. The other is generated in real time and varies for each user inquiry, outputting advice specific to that inquiry and how it relates to the law, known as post-prompt analysis. In more detail, analysis can be created either through AI or manually input analysis by legal scholars. Further, the AI NLP is capable of understanding a document or interpreting the law. Then, based on its findings, another AI text generator creates the various aforementioned outputs.

In summary, FIGS. 1-5 discussed in detail above illustrate the holistic system architecture of the present invention. A user can tap into the ULA by initially going through the process of authentication and authorization using facial recognition, voice recognition, or manual login.

The present invention also retrieves the user's Global Positioning System (GPS) location, if given permission. Then the user submits an inquiry using a smart device. An AI service processes the inquiry, searches the cloud data aggregation layer (DAL) for the most relevant laws and analysis, then returns the results to the user. The DAL utilizes numerous AI services to browse through a variety of law sources and compile the necessary ones, then storing and analyzing them. In addition, legal scholars can contribute written analysis to the laws in the DAL.

The advantages of the present invention include, without limitations, accessibility to legal advice and information by anyone, without cost, and at self-discretion, along with specialized services for legal scholars and lawyers that boost knowledge in the field. In addition, by drawing on a large quantity of laws and other relevant data, the information provided is comprehensive and accurate to specific user requests.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A Universal Legal Aid (ULA) comprising:
an Identity & Location Authenticator (ILA) receives legal requests from multiple users and submits said requests to a Universal Legal Access Platform (ULAP) after authentication;
said ULAP comprises a Retrieval Service (RS) for receiving said legal requests;
said RS connects to an Analysis Service (AS);
said AS and RS both communicate with a Data Aggregation Layer (DAL); and
a Compilation Service (CS) for compiling all appropriate information from said DAL; a Display for displaying legal request results of said ULAP.

2. The ULA as claimed in claim 1, wherein:
said CS comprises a Data Compilation Unit (DCU) compiles both structured and unstructured data before feeding results to said DAL.

3. The ULA as claimed in claim 1, wherein:
said RS comprises an Artificial Intelligence (AI) Natural Language Processor (NLP) feeding information to an AI Data Search Unit (DSU);
a Law Text & Source Unit (LTSU); and
said DSU communicates with said DAL.

4. The ULA as claimed in claim 3, wherein:
said AI NLP receives information from said LTSU and feeds them to an AI Text Generator;
a Pre-Inquiry Analysis Service and a Post-Inquiry Analysis Service both receive information from said AI Text Generator; and
output of said Post-Inquiry Analysis Service is feeding into said DAL.

5. The ULA as claimed in claim 1, wherein: said ULAP draws its law information from various domains, all through Cloud Processing (CP).

6. The ULA as claimed in claim 1, wherein:
said DAL contains laws of all nations from the national/federal to the local level.

7. The ULA as claimed in claim 1, wherein:
said ILA comprising any biometric authentication, GPS, Bluetooth and Wi-Fi.

8. A method of using a Universal Legal Aid (ULA) comprising the steps of:
obtaining authorization to use the ULA;
identifying location and authenticate identity of said user;
submitting legal related inquires to the ULA after said authorization;
sending said inquiries to a Receiving Service (RS) for processing;
scouring diverse legal sources across numerous domains;
outcome of said scouring process is a consolidated repository of said legal inquiries;
and
said outcome is displayed in a text report format on a display.

9. The method of using a Universal Legal Aid (ULA) as claimed in claim 8, wherein:
said scouring is performed through an Analysis Service (AS) and stored in a Data Aggregation Layer (DAL).

10. The method of using a Universal Legal Aid (ULA) as claimed in claim 9, wherein:
interconnection between the user's ULA and the DAL permits seamless access to cloud-hosted services and essential legal insights.

11. The method of using a Universal Legal Aid (ULA) as claimed in claim 9, said Analysis Service (AS) is made up of two kinds of analysis:
a) one is inherently tied to each individual law, known as pre-inquiry analysis; and
b) the other is generated in real time and varies for each unique user inquiry, known as post-prompt analysis; wherein:
said analysis can be created either through AI or manually input by legal scholars.
